(19) United States
(12) Patent Application Publication
(10) Pub. No.: US 2010/0026004 A1
(43) Pub. Date: Feb. 4, 2010

(54) FLOATING TYPE WIND POWER GENERATION APPARATUS

(76) Inventor: Shih H. CHEN, Yongkang City (TW)

Correspondence Address: HDLS Patent & Trademark Services, P.O. BOX 220746, CHANTILLY, VA, 20153-0746, US

(21) Appl. No.: 12/185,281

(22) Filed: Aug. 4, 2008

(51) Int. Cl. F03D 9/00; F03D 11/04

(52) U.S. Cl. 290/55

(57) ABSTRACT

A floating type wind power generation apparatus includes a floating vehicle, a frame, and a plurality of wind power generators. The frame is installed on the floating vehicle. The wind power generators are mounted to the frame, respectively, wherein each of the wind power generators includes a wind-shell, a wind-wheel arranged inside the wind-shell, and a power generator motor connected to the wind-wheel.

### BACKGROUND OF THE INVENTION

1. Field of the Invention

The present invention relates to a wind power generation apparatus, in particular to a floating type wind power generation apparatus.

2. Description of Related Art

With excessive exploiting and consuming, the total amount of underground petroleum natural resources is decreasing gradually, and the market price thereof is rising. Carbon dioxide gas generated from massive consumption of petroleum fuel is a major cause of the ozone layer depletion and the greenhouse effect. Based on this, solutions which able to provide renewable energy generated from wind, solar or water power are under extensive research and development.

Conventional wind power generation apparatus for renewable energy is usually installed on the ground. The loud operating noises generated from the wind power generation apparatus is not bearable for residents nearby. Therefore, the wind power generation apparatus is usually installed on the sparsely populated areas. Besides, the percentage of the land area of the earth's surface is about 30, it further limits the area on which the wind power generation apparatus can be installed. Therefore, in order to solve the above problem, a wind power generation apparatus is desirable to install on the sea bed.

A conventional wind power generation apparatus for installing on the sea bed mainly includes a station frame and a wind power generator. The wind power generator is arranged on the station frame and above the sea surface. The wind power generator includes a power generator motor and a wind-wheel mounted to the power generator motor. The wind-wheel is rotated by wind force to drive the power generator motor to generate electricity for output.

However, the wind power generation apparatus is difficult to install on the sea bed, it needs to fix a base on the sea bed first, and then the station frame can be mounted on the base, and the wind power generator can be mounted on the station frame. The mounting process is difficult, complicated and inconvenient, and causes wasting of time. Besides, the costs of mounting process and related materials are quite expensive.

Therefore, in order to solve the abovementioned problems, the inventor of the present invention is steadily researching and utilizes relative theories to provide the present invention which is reasonably designed and is able to effectively solve the abovementioned problems.

### SUMMARY OF THE INVENTION

The subject of present invention is to provide a floating type wind power generation apparatus, capable of decreasing the costs of the manufacturing.

The subject of present invention is to provide a floating type wind power generation apparatus, capable of assembling convenient and saving assembling time.

The subject of present invention is to provide a floating type wind power generation apparatus, capable of achieving the optimal effect of electricity generation.

In order to achieve aforementioned purpose, the present invention provides a floating type wind power generation apparatus including a floating vehicle, a frame, and a plurality of wind power generators. The frame is installed on the floating vehicle. The wind power generators are mounted to the frame, respectively, wherein each of the wind power generators includes a wind-shell, a wind-wheel arranged inside the wind-shell, and a power generator motor connected to the wind-wheel.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a first embodiment of the present invention;

FIG. 2 is a perspective view of the first embodiment of the present invention;

FIG. 3 is a perspective view of the first embodiment of the present invention; and

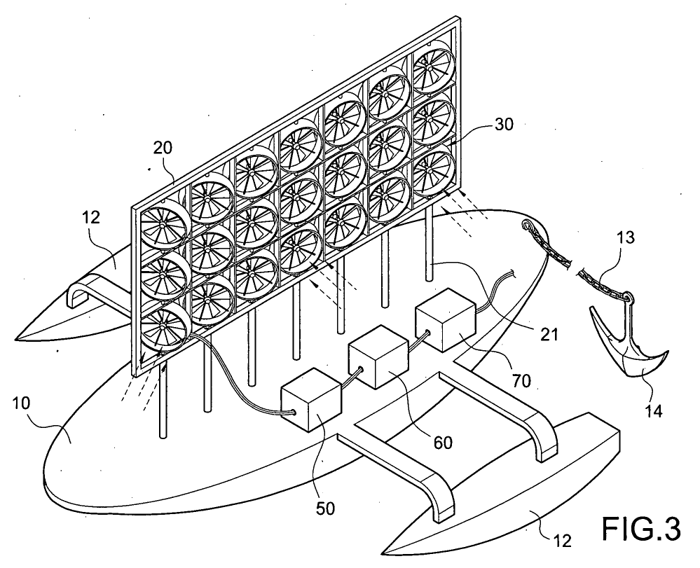

FIG. 4 is a perspective view of a second embodiment of the present invention.

### DETAILED DESCRIPTION OF THE INVENTION

A detailed description of the present invention will be made with reference to the accompanying drawings.

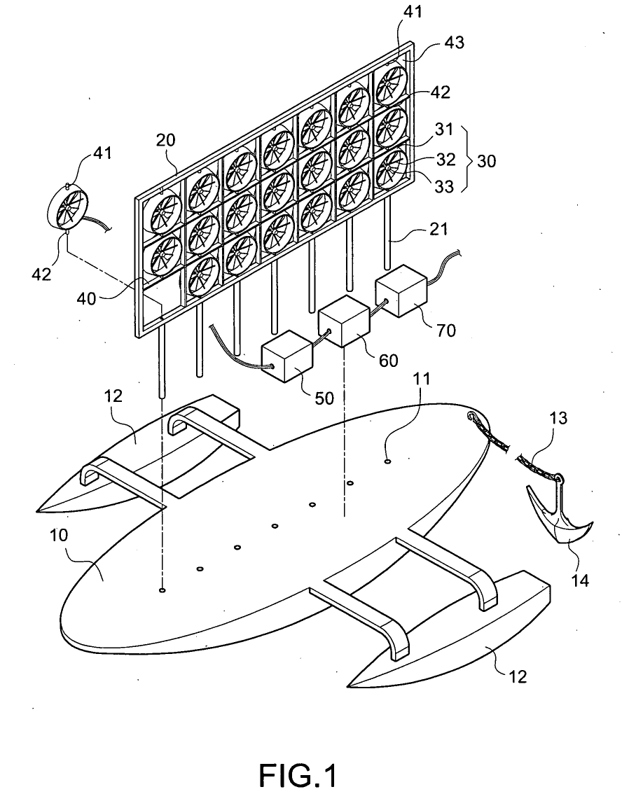

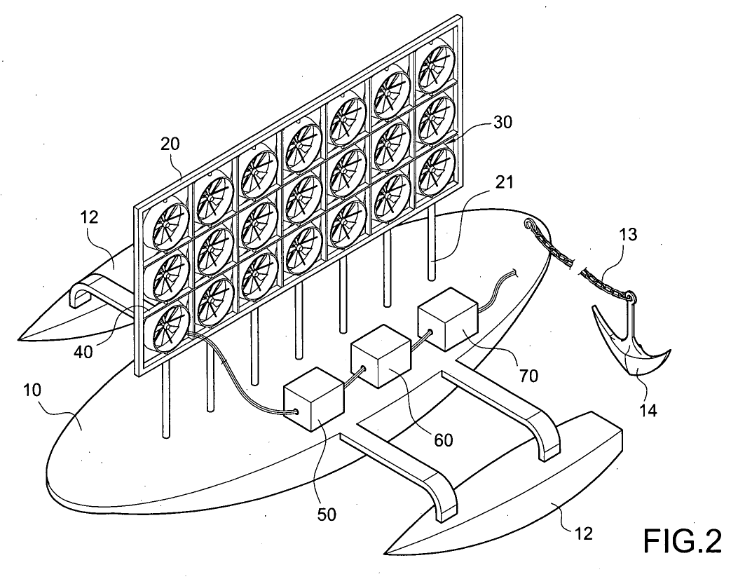

Refer to FIG. 1 and FIG. 2, a first embodiment of the floating type wind power generation apparatus mainly includes a floating vehicle 10, a frame 20 and a plurality of wind power generator 30.

The floating vehicle 10 can be a hollow floating body. A plurality of holes 11 are formed on a top portion of the floating vehicle 10. A bottom portion of the floating vehicle 10 is of arc-shaped and the floating vehicle 10 is substantially of an ellipsoid-shape. Therefore, the resistant force is decreased when the floating vehicle 10 is moving through the sea. Besides, two floating blocks 12 are respectively connected to two different sides of the floating vehicle 10 to stabilize the floating vehicle 10 moving through the sea, and to prevent the floating vehicle 10 from slanting when suffering a strong wind. An anchor 14 is linked to the floating vehicle 10 through a connecting chain 13. The anchor 14 is used to dip into the sea to fix the position of the floating vehicle 10. The two floating blocks 12 can be assembled with the floating vehicle 10 to constitute a catamaran sail. Further more, three of the floating blocks can be assembled with the floating vehicle 10 to constitute a tricat sail.

The frame 20 is installed on the floating vehicle 10 through a plurality of supporting posts 21 connected to a side of the frame 20. A plurality of holes 11 are formed on the floating vehicle 10 for mounting the supporting posts 21. In this embodiment, the frame 20 is of rectangular-shape, but not limited thereto. Besides, a warning light can be mounted on the frame 20 to avoid collisional accident in the dark night.

The wind power generators 30 are mounted to the frame 20, respectively, wherein each of the wind power generators 30 includes a wind-shell 31, a wind-wheel 32 arranged inside the wind-shell 31, and a power generator motor 33 connected to the wind-wheel 32. The orientation of the wind-shell 31 can be changed spontaneously by the wind blowing to face forward the wind. The wind-shell 10 can be a concentrator, a diffuser or a combination of them. The shape of the wind-shell 10 can be a circle or a rectangular. Besides, wind power generators 30 is preferred to be a small volume wind power generators, thus the volume of the wind-wheel 32 and the power generator motor 33 can be saved as well as the costs of the manufacturing.

In this embodiment, the wind power generation apparatus of the present invention further includes a plurality of spacing plates 40 connected to the frame 20, a first rod 41 connected between the wind-shell 10 and the frame 20, a second rod 42 connected between the wind-shell 10 and the spacing plate 40, the spacing plates 40 form a plurality of chambers 43 for accommodating the wind power generators 30 therein, respectively. The first rod 41 and the second rod 42 are arranged to align a predetermined axis, and wherein the wind power generators 30 are rotatable around the predetermined axis.

In this embodiment, the wind power generation apparatus of the present invention further includes a control unit 50, storage unit 60, and a transform unit 70. The control unit 50 is electrically connected to the power generator motors 33 to convert the electrical voltage generated by the power generator motors 33 to an electrical power. The storage unit 60 is electrically connected to the control unit 50 to store the electrical power outputted by control unit 50. The transform unit 70 is electrically connected to the storage unit 60 to transform the direct current thereof to an alternating current.

In assembling the wind power generation apparatus of the present invention, as FIG. 2 shows, the wind power generators 30 are mounted on the frame 20 in advance, then the frame 20 will be installed on the floating vehicle 10 to finish the assembling task in a convenience way, or the frame 20 is installed on the floating vehicle 10 in advance, then the wind power generators 30 are mounted on the frame 20. After abovementioned assembling task is finished on the land, the wind power generation apparatus is dragged on a sea surface. Thus, the present invention has advantages of assembling convenience, saving assembling time and decreasing manufacturing costs.

After the wind power generation apparatus is dragged on a sea surface, the anchor 14 can be dipped into the sea to remain the position of the floating vehicle 10. The wind power generators 30 can change their orientations automatically to face the wind so as to achieve the optimal effect of electricity generation.

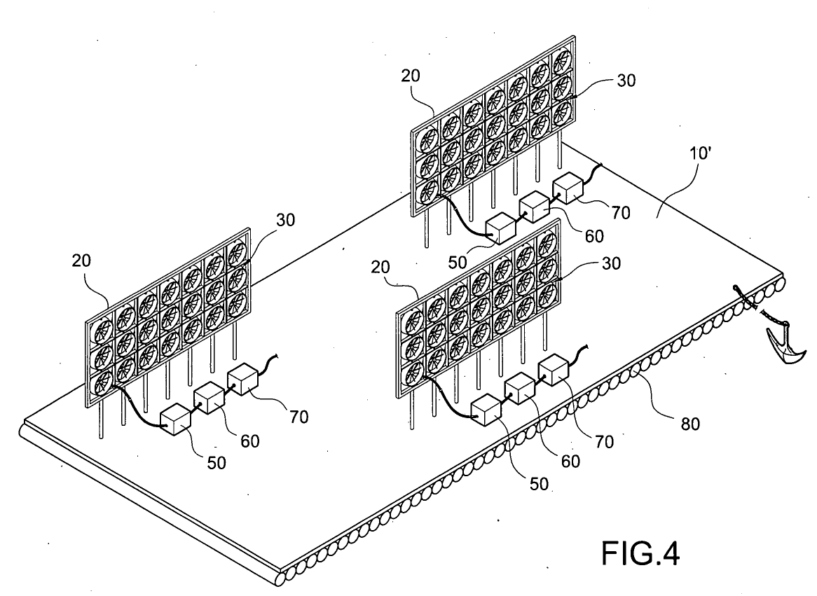

Refer to FIG. 4, a second embodiment of the present invention, the differences between the second embodiment and the first embodiment is that the second embodiment further includes a plurality of floating barrels 80 arranged on a bottom face of a floating vehicle 10′. The floating vehicle 10′ is a rectangular-shaped floating body. A plurality of frames 20 are installed on the floating vehicle 10′ and a plurality of wind power generators 30 are mounted to the frames 20, respectively. This design of the floating vehicle 10′ further improves the stability of floating on the sea surface and prevents the floating vehicle 10′ from slanting when suffering a strong wind. The floating barrels 80 are used to increase the float capability of the floating vehicle 10′ to carry the frames 20 and the wind power generators 30 thereon. The electricity generation efficiency is further increased by the frames 20 and the wind power generators 30.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A floating type wind power generation apparatus, comprising:
a floating vehicle;
a frame installed on the floating vehicle; and
a plurality of wind power generators mounted to the frame, respectively, wherein each of the wind power generators comprises a wind-shell, a wind-wheel arranged inside the wind-shell, and a power generator motor connected to the wind-wheel.

2. The apparatus according to claim 1, further comprising a plurality of spacing plates connected to the frame, a first rod connected between the wind-shell and the frame, a second rod connected between the wind-shell and the spacing plate, the spacing plates form a plurality of chambers for accommodating the wind power generators therein, respectively.

3. The apparatus according to claim 2, wherein the first rod and the second rod are arranged to align a predetermined axis, and wherein the wind power generators are rotatable around the predetermined axis.

4. The apparatus according to claim 1, further comprising two floating blocks respectively connected to two different sides of the floating vehicle.

5. The apparatus according to claim 1, further comprising an anchor and a connecting chain linking the anchor to the floating vehicle.

6. The apparatus according to claim 1, further comprising a control unit electrically connected to the power generator motors to convert the electrical voltage generated by the power generator motors to a electrical power.

7. The apparatus according to claim 6, further comprising a storage unit electrically connected to the control unit to store the electrical power outputted by the control unit.

8. The apparatus according to claim 7, further comprising a transform unit electrically connected to the storage unit to transform the direct current thereof to an alternating current.

9. The apparatus according to claim 1, further comprising a plurality of supporting posts connected to a side of the frame, and a plurality of holes formed on the floating vehicle for mounting the supporting posts.

10. The apparatus according to claim 1, further comprising a plurality of floating barrels arranged on a bottom face of the floating vehicle.
